(19) United States
(12) Patent Application Publication
(10) Pub. No.: US 2014/0102561 A1
(43) Pub. Date: Apr. 17, 2014

(54) QUICK-RELEASE CONNECTORS AND CONNECTION ASSEMBLIES FOR FLUIDIC COUPLING

(71) Applicant: Paul J. Wright, Cambridge (GB)

(72) Inventor: Paul J. Wright, Cambridge (GB)

(73) Assignee: DIBA INDUSTRIES, INC., Danbury, CT (US)

(21) Appl. No.: 14/050,996

(22) Filed: Oct. 10, 2013

Related U.S. Application Data
(60) Provisional application No. 61/712,498, filed on Oct. 11, 2012.

(51) Int. Cl. F16L 37/38

(52) U.S. Cl. CPC F16L 37/38
USPC 137/528

(57) ABSTRACT

Quick-release connectors and connection assemblies comprising the quick-release connectors include an inlet coupling and an outlet coupling. A compressible check valve in the inlet coupling may be formed from a resilient elastomeric material. A plunger body in the outlet-coupling proximal portion may include a plunger neck portion, a plunger channel, and a plunger inlet. An outlet valve in the outlet coupling may prevent reverse fluid flow in the outlet coupling. In a disconnected state of the connector, a check valve contact surface of the compressible check valve seals against a sealing member to prevent fluid flow thorough the inlet coupling. In a connected state of the connector, the plunger neck portion protrudes through the sealing member and compresses the compressible check valve to place the plunger inlet in fluidic communication with a valve clearance opened between the check valve contact surface and the sealing member.

### CROSS-REFERENCES TO RELATED APPLICATIONS

This application claims the benefit of priority under 35 U.S.C. §119(e) to U.S. Provisional Application Ser. No. 61/712,498, filed Oct. 11, 2012.

### TECHNICAL FIELD

The present specification relates to fluidic coupling devices and, more particularly, to quick-release connectors for use as fluidic coupling devices.

### BACKGROUND

Fluidic coupling devices such as connectors find applications in industry, laboratory research, and even in the home. In some applications, it may be desirable to use a connector to quickly connect a first fluid line, such as a hose or other tubing, to a second fluid line. In such applications, quick connection may be facilitated by a connector assembly, in which one part of the connector assembly is secured to the first fluid line and another part of the connector assembly is secured to the second fluid line. Thereby, connection of the first fluid line to the second fluid line can involve simply connecting the two parts of the connector assembly.

Though some types of quick-release valved and non-valved fluid connectors have been used in varied applications, they generally incorporate a spring and seal arrangement that is mechanically activated during connection and disconnection procedures to allow or prevent flow through the device. Therefore, there remains a continuing need for improvement with regard to complexity, price, chemical resistance, and size of quick-release connectors.

### SUMMARY

Against the above background, embodiments herein are directed to connectors that may include an inlet coupling having an inlet-coupling proximal portion, an inlet-coupling distal portion adapted to accommodate an inlet fitting, and an inlet channel providing fluidic communication between the inlet-coupling distal portion and an inlet-coupling proximal portion outlet of the inlet-coupling proximal portion. A sealing member may be provided at the inlet-coupling proximal portion outlet. A compressible check valve may be provided between the sealing member and the inlet channel. The compressible check valve may be formed from a resilient elastomeric material. The connectors further include an outlet coupling having an outlet-coupling proximal portion, an outlet-coupling distal portion adapted to accommodate an outlet fitting, and an outlet channel providing fluidic communication between the outlet-coupling proximal portion and the outlet-coupling distal portion. A plunger body may be disposed in the outlet-coupling proximal portion. The plunger body may include a plunger neck portion, a plunger channel defined through the plunger body, and a plunger inlet on the plunger neck portion and in fluidic communication with the plunger channel. An outlet valve may be provided between the plunger channel and the outlet channel. The outlet valve may prevent fluid flow from the outlet channel to the plunger channel and may allow fluid flow from the plunger channel to the outlet channel. Thus, in a disconnected state of the connector, a check valve contact surface of the compressible check valve forms a seal against the sealing member that prevents fluid flow from the inlet channel to the inlet-coupling proximal portion outlet. In a connected state of the connector, the plunger neck portion protrudes through the sealing member and compresses the compressible check valve to place the plunger inlet in fluidic communication with a valve clearance opened between the check valve contact surface and the sealing member when the compressible check valve is compressed.

Further embodiments herein may be directed to connection assemblies that include a connector according to any of the embodiments described above. The connection assemblies may further include an inlet fitting coupled to the inlet-coupling distal portion and an outlet fitting coupled to the outlet-coupling distal portion. The inlet fitting may secure an inlet tubing to be in fluidic communication with the inlet channel. The outlet fitting may secure an outlet tubing to be in fluidic communication with the outlet channel. Thus, in a disconnected state of the connector, a check valve contact surface of the compressible check valve forms a seal against the sealing member that prevents fluid flow from the inlet channel to the inlet-coupling proximal portion outlet. In a connected state of the connector, the plunger neck portion protrudes through the sealing member and compresses the compressible check valve to place the plunger inlet in fluidic communication with a valve clearance opened between the check valve contact surface and the sealing member when the compressible check valve is compressed, thereby enabling unidirectional fluidic communication between the inlet tubing and the outlet tubing.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a perspective view of one embodiment of an assembled connection assembly;

FIG. 2 is a cross-section view of a connection assembly according to embodiments described herein;

FIG. 3A is a perspective view of another embodiment of an assembled connection assembly;

FIG. 3B is a perspective view of the connection assembly of FIG. 3A in a disassembled state;

FIG. 4A is a bottom perspective view of a check-valve, a component of the connection assemblies of FIGS. 1, 2, 3A, and 3B, according to some embodiments;

FIG. 4B is a top perspective view of the compressible check valve of FIG. 4A.

FIG. 5A is a perspective view of an unassembled connection assembly according to some embodiments, in which the components of the connection assembly have been coupled with threaded fittings;

FIG. 5B is a cross-section of the unassembled connection assembly of FIG. 5A with threaded fittings;

FIG. 6 is a detail view of the compressible check valve in an unassembled connection assembly;

FIG. 7A is a perspective view of an assembled connection assembly according to some embodiments, in which the components of the connection assembly have been coupled with threaded fittings;

FIG. 7B is a cross-section of the assembled connection assembly of FIG. 7A with threaded fittings; and

FIG. 8 is a detail view of an assembled connection assembly showing a fluidic pathway through the connected connection assembly.

### DETAILED DESCRIPTION

Embodiments herein are directed to quick-release connectors that are quick to connect and disconnect. When connected, the quick-release connectors enable unidirectional fluid flow from an inlet fitting to an outlet fitting. When disconnected, the quick-release connectors prevent fluid from flowing out of the inlet fitting and the outlet fitting. Exemplary embodiments of quick-release connectors will now be described. In the exemplary embodiments, it is noted that the quick-release connectors described with reference to the figures may contain valve elements and tubing connections, in which a female member is present, and into which female member a threaded male fitting may be attached, for example. It should be understood, however, that the components and functionality of the quick-release connectors may be preserved in alternative embodiments, in which a male member may be present on the quick-release connector, which male member may be adapted to be connected to a female-type fitting.

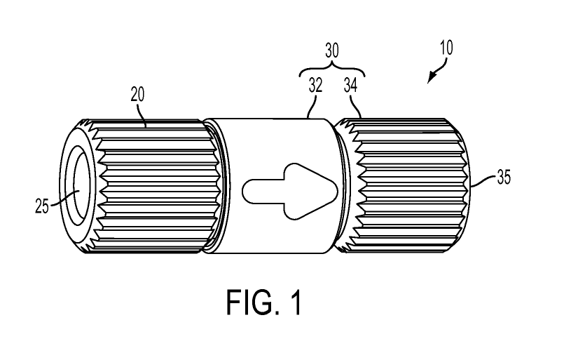

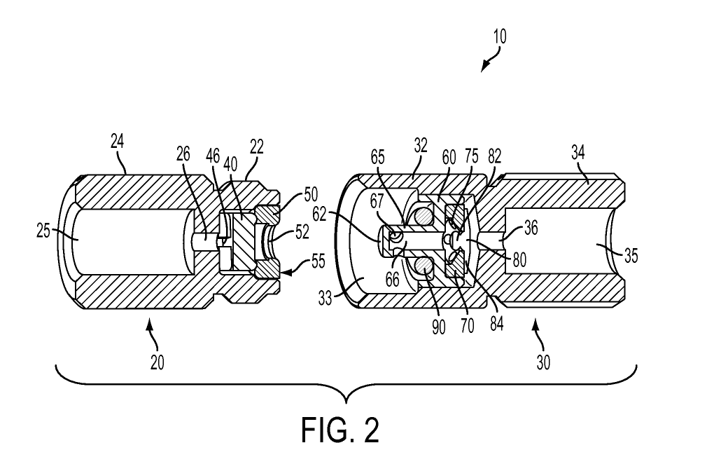

Referring to FIGS. 1 and 2, a quick-release connector 10 may include two connectable couplings such as an inlet coupling 20 and an outlet coupling 30. The inlet coupling 20 and an outlet coupling 30 are configured to be quickly connected and disconnected. In the embodiment of FIGS. 1 and 2, for example, the inlet coupling 20 may be received in the outlet coupling 30 by a snap-fit connection against an outlet-coupling receiving wall 33. The outlet-coupling receiving wall 33 may be smooth, such that the inlet coupling 20 may be secured by friction. Optionally, the outlet-coupling receiving wall 33 and the inlet coupling 20 may be threaded.

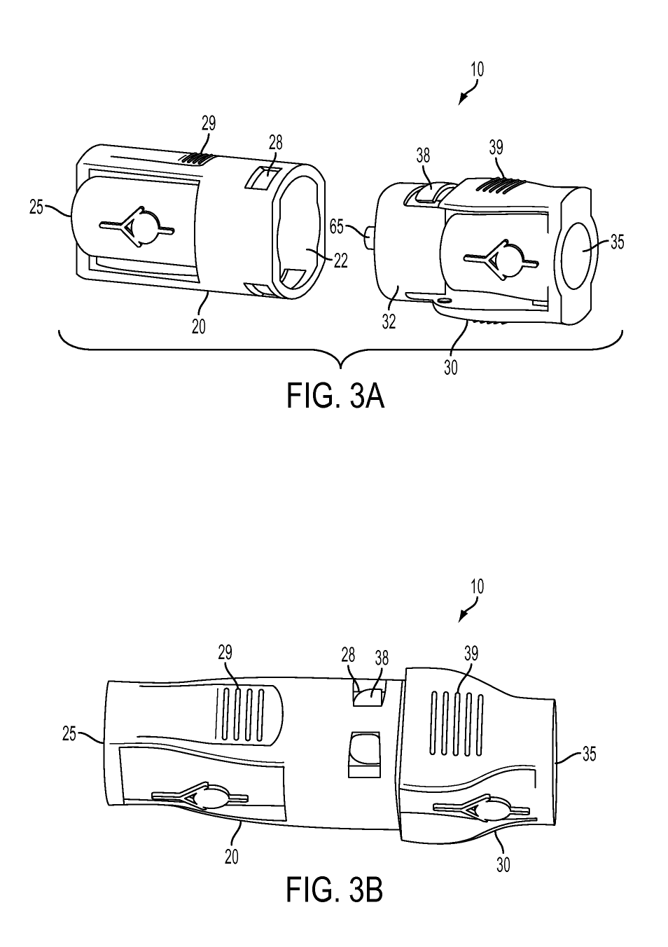

In an alternative embodiment shown in FIGS. 3A and 3B, the inlet coupling 20 may include at least one coupling notch 28, and the outlet coupling 30 may include at least one coupling latch 38 that engages the at least one coupling notch 28 when the inlet coupling 20 and the outlet coupling 30 are connected. The at least one coupling latch 38 may be disposed at an end of a release lever 39, such that the inlet coupling 20 snaps into the outlet coupling 30 and such that the inlet coupling 20 and the outlet coupling 30 may be disconnected by pressing down on the release lever 39 to disengage the at least one coupling latch 38. Disconnection of the inlet coupling 20 from the outlet coupling 30 may be facilitated further by finger grips 29 on the inlet coupling 20, on the release lever 39, or both. The at least one coupling notch 28 may be present on the inlet coupling 20 (as shown) or on the outlet coupling 30 (not shown), provided at least one of the inlet coupling 20 and the outlet coupling 30 includes at least one coupling notch 28. Likewise, the at least one coupling latch 38 may be present on the outlet coupling 30 (as shown) or on the inlet coupling 20 (not shown), provided at least one of the inlet coupling 20 and the outlet coupling 30 includes at least one coupling latch 38. It should be noted that the alternative embodiment of FIGS. 3A and 3B is provided to illustrate an alternative mechanism by which the inlet coupling 20 and the outlet coupling 30 may be secured to each other. In further embodiments of quick-release connectors described herein, it should be understood that the securing mechanism of FIGS. 3A and 3B may be present as an alternative embodiment, even when the illustration of the embodiment includes only the securing mechanism according to FIGS. 1 and 2.

In the quick-release connector 10, the inlet coupling 20, the outlet coupling 30, or both may be constructed of any plastic material suitable for fluidic connectors such as, for example, PEEK, PVD, polyacetal, polypropylene, or blends thereof. In other embodiments, the inlet coupling 20, the outlet coupling 30, or both may be constructed of any metal suitable for fluidic devices such as stainless steel, plated brass, or titanium, for example.

The quick-release connector 10 may exist in a connected state or a disconnected state. As used herein, the term “connected state” refers to when the inlet coupling 20 and the outlet coupling 30 are physically connected, regardless of whether any fittings are attached to the inlet coupling 20 or the outlet coupling 30. Thus, the term “disconnected state” refers to which the inlet coupling 20 and the outlet coupling 30 are not physically connected, regardless of whether any fittings are attached to the inlet coupling 20 or the outlet coupling 30. As used herein with regard to the quick-release connector 10 or its components, specifically the inlet coupling 20 and the outlet coupling 30, unless stated otherwise, the term “proximal” refers to a portion of a component that is closest to the location where the inlet coupling 20 and the outlet coupling 30 are connected when the quick-release connection 10 is in the connected state. Likewise, unless stated otherwise, the term “distal” refers to a portion of a component that is farthest from the location where the inlet coupling 20 and the outlet coupling 30 are connected when the quick-release connection 10 is in the connected state.

Referring particularly to FIGS. 1 and 2, and also as applicable to the alternative embodiment of FIGS. 3A and 3B, the inlet coupling 20 may include an inlet-coupling proximal portion 22 and an inlet-coupling distal portion 24. An inlet channel 26 may be defined between the inlet-coupling proximal portion 22 and the inlet-coupling distal portion 24 to permit fluidic communication between the inlet-coupling proximal portion 22 and the inlet-coupling distal portion 24. The inlet-coupling distal portion 24 includes an inlet entrance 25. The inlet entrance 25 may be adapted with a feature such as threaded walls, for example to accommodate fitting assemblies, as will be described in greater detail below. In alternative embodiments not shown, the inlet entrance 25 may be configured as a male-type fitting (instead of the female-type fitting that is shown), such that the inlet-coupling distal portion 24 may be connected to a female-type fitting assembly if desired, rather than the male-type fitting that would be appropriate for the embodiment of FIG. 2.

Referring to FIG. 2, a compressible check valve 40 may be seated inside the inlet-coupling proximal portion 22. The compressible check valve 40, which will be described in greater detail below, may be interposed between the inlet channel 26 and a sealing member 50. The sealing member 50 may include a sealing surface 55 and may define an inlet-coupling proximal portion outlet 52 of the inlet-coupling proximal portion 22. In some embodiments, the sealing member 50 may be constructed of any plastic material suitable for fluidic sealing applications such as, for example, PEEK, PVC, polyacetal, polypropylene, or blends thereof. The sealing member 50 may have any shape, size, or thickness that is required for providing a fluid-tight or substantially fluid-tight seal. In the embodiment of FIG. 2, the sealing member 50 is a ring made of a plastic, polymer, or metal. The sealing member 50 may also include features such as notches on the side facing the compressible check valve 40, so as to increase effectiveness of a seal between the sealing member 50 and the compressible check valve 40.

The outlet coupling 30 may include an outlet-coupling proximal portion 32 and an outlet-coupling distal portion 34. An outlet channel 36 may be defined between the outlet-coupling proximal portion 32 and the outlet-coupling distal portion 34 to establish fluidic communication between the outlet-coupling proximal portion 32 and the outlet-coupling distal portion 34. The outlet-coupling proximal portion 32 may be configured as a female counterpart to the male-type features of the inlet-coupling proximal portion 22 of the inlet coupling 20. In alternative embodiments not shown, the outlet-coupling proximal portion 32 may be configured as a male counterpart to female-type features on the inlet-coupling proximal portion 22 of the inlet coupling 20.

The outlet-coupling distal portion 34 includes an outlet exit 35. The outlet exit 35 may be adapted to accommodate fitting assemblies with a feature such as threaded walls, as will be described in greater detail below. In alternative embodiments not shown, the outlet exit 35 may be configured as a male-type fitting (instead of the female-type fitting that is shown), such that the outlet-coupling distal portion 34 may be connected to a female-type fitting assembly if desired, rather than the male-type fitting that would be appropriate for the embodiment of FIG. 2.

The outlet coupling 30 may also include a plunger body 60 and an outlet valve 80. In some embodiments, the outlet coupling 30 may further include an outlet valve retainer 70 and a plunger seal 90. The plunger body 60 may include a plunger neck portion 65, and the plunger neck portion 65 may have a plunger channel 66 defined therein. The plunger neck portion 65 may include a compressing surface 62 and at least one plunger inlet 67. The at least one plunger inlet 67 may be disposed at or near the compressing surface 62 through a side of the plunger neck portion 65 to allow fluid to flow laterally into the plunger channel 66. The plunger seal 90 may be seated around the plunger neck portion 65. The outlet valve retainer 70 may be interposed between the plunger body 60 and the outlet valve 80 and may include at least one retainer outlet 75 that establishes fluidic communication between the plunger channel 66 and the outlet channel 36 when the outlet valve 80 is open. In some embodiments, the plunger body 60, the outlet valve retainer 70, or both may be constructed of any plastic material suitable for the fluidic applications for which the quick-release connector 10 is intended such as PEEK, PVC, polyacetal, polypropylene, or blends thereof, for example. In other embodiments, the plunger body 60, the outlet valve retainer 70, or both may be constructed of any metal suitable for use in fluidic devices such as stainless steel, plated brass, or titanium, for example.

In the embodiments of FIGS. 1 and 2, and as applicable to the alternate embodiment of FIGS. 3A and 3B, two valve elements may be present in the quick-release connector 10: the compressible check valve 40 in the inlet coupling 20, and the outlet valve 80 in the outlet coupling 30. In exemplary embodiments, both the compressible check valve 40 and the outlet valve 80 may be constructed of any elastomer material having flexibility and resilience. As non-limiting examples, the compressible check valve 40 and the outlet valve 80 may be constructed of EPDM rubber, FKM/FPM rubber, FFKM rubber, nitrile rubber, isoprene rubber, or silicone. In the disconnected state of the quick-release connector 10, both the compressible check valve 40 and the outlet valve 80 are normally closed. In the connected state of the quick-release connector 10, both the compressible check valve 40 and the outlet valve 80 are configured to permit fluid flow in only one direction from the inlet channel 26 to the outlet channel 36. The compressible check valve 40 and the outlet valve 80 do not require reverse fluid pressure to function. Specific features of the compressible check valve 40 and the outlet valve 80 will now be described.

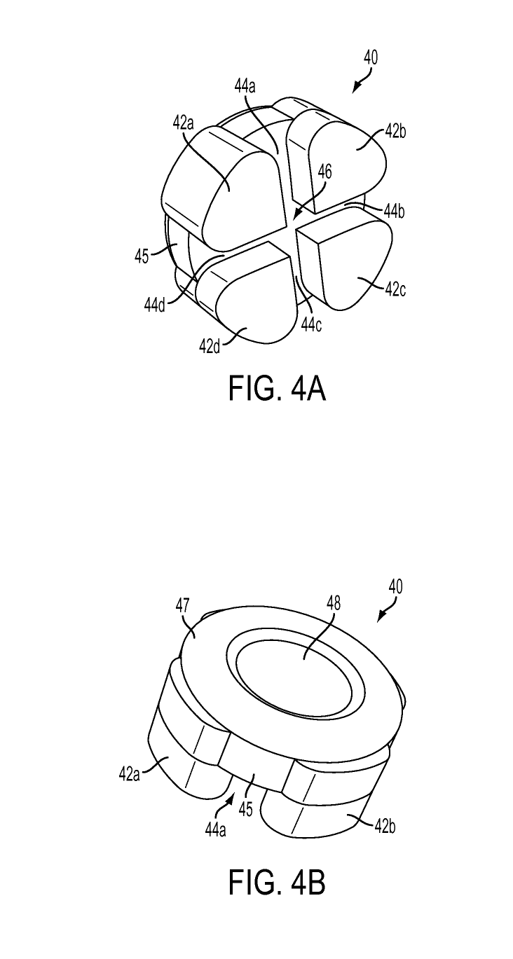

With regard to the compressible check valve 40, referring to FIGS. 4A and 4B, the compressible check valve 40 may include a check valve base 45 having check valve legs 42a, 42b, 42c, 42d attached thereto. The check valve legs 42a, 42b, 42c, 42d have sufficient height with respect to the check valve base 45 and sufficient distance between each other to define check valve passages 44a, 44b, 44c, 44d bound on one side by the check valve base 45 and on two sides by neighboring check valve legs. For example, check valve passage 44a is bound by the check valve base 45 and check valve legs 42a, 42b that are adjacent to each other. In the embodiment of FIGS. 4A and 4B, the compressible check valve 40 includes four of the check valve legs 42a, 42b, 42c, 42d, adjacent legs of which define the check valve passages 44a, 44b, 44c, 44d. In further embodiments, the compressible check valve 40 may include at least two check valve legs such as, for example, two, three, four, five, six, or more than six check valve legs, and at least one check valve passage may be defined between each adjacent check valve leg.

The intersection of the check valve passages 44a, 44b, 44c, 44d may define a passage junction 46. When the compressible check valve 40 is seated in the inlet coupling 20, for example, the passage junction 46 may be disposed directly over the inlet channel 26 (see FIG. 2). The check valve base 45 may include a check valve contact surface 48. The check valve contact surface 48 may be continuous and impervious to fluid. The check valve contact surface 48 may include a check valve rim 47 raised around an outer periphery of the check valve contact surface 48 to facilitate tight sealing against the sealing member 50, for example. The check valve legs 42a, 42b, 42c, 42d are attached to the check valve base 45 opposite the check valve contact surface 48. In this context, the term “attached” means physically connected and encompasses embodiments in which the check valve legs 42a, 42b, 42c, 42d and the check valve base 45 are separate parts that are joined by an adhesive, for example, and also embodiments in which the check valve legs 42a, 42b, 42c, 42d and the check valve base 45 are formed as a unitary body, such as by molding the compressible check valve 40 as a single piece. In a disconnected state of the quick-release connector 10, the check valve contact surface 48 of the compressible check valve 40 forms a seal against the sealing member 50 that prevents fluid flow from the inlet channel 26 to the inlet-coupling proximal portion outlet 52.

As a whole, the compressible check valve 40 may be compressible and have resilience that enables the compressible check valve 40 to revert to its original shape in the disconnected state of the quick-release connector 10 after being compressed while the quick-release connector 10 is in the connected state. The compressibility of the compressible check valve 40 as it may affect fluid flow conditions in the quick-release connector 10 will be described in greater detail below.

In some embodiments, the compressible check valve 40 may be formed as a single unitary body without any seams or joints, such as by molding or other suitable technique. The compressible check valve 40 may also include multiple pieces, such as the check valve base 45 and the check valve legs 42a, 42b, 42c, 42d that are formed independently but are permanently joined or attached such as by gluing, for example. In preferred embodiments, the compressible check valve 40 is a single unitary body that is compressible and resilient but does not include any mechanical components such as a ball or a spring. In other preferred embodiments, the quick-release connector 10 as a whole does not include any mechanical components such as balls or springs, particularly any mechanical components that would take on the function of a valve to prevent fluid flow.

The outlet valve 80 may be any type of valve structure that permits only unidirectional fluid flow from the plunger channel 66 to the outlet channel 36. As shown in the non-limiting embodiment of FIG. 2, the outlet valve 80 may be an umbrella valve. When an umbrella valve is used as the outlet valve 80, the outlet valve 80 may include an outlet valve head 82 and an outlet valve rim 84. The outlet valve head 82 may be configured to hold the outlet valve 80 in the outlet valve retainer 70. The outlet valve rim 84 may extend laterally across a surface of the outlet valve retainer 70 so as to cover all of the retainer outlets 75. Owing to this configuration of the outlet valve rim 84 as an umbrella valve, the outlet valve 80 prevents fluid flow from the outlet channel 36 to the at least one retainer outlet 75, because the “reverse” pressure from such fluid flow simply seals the outlet valve rim 84 more tightly against the at least one retainer outlet 75. Even so, the outlet valve 80 configured as the shown umbrella valve is normally closed, requiring no reverse pressure to seal. On the other hand, fluid flow is made possible in the opposite direction (from the at least one retainer outlet 75 into to the outlet channel 36) above a threshold flow pressure, because the “forward” pressure from such fluid flow may be sufficient to bend the outlet valve rim 84 away from the at least one retainer outlet 75. The threshold flow pressure may be tailored to an intended application, based on the material type and structure of the outlet valve 80, particularly with respect to the flexibility and resilience of the outlet valve 80.

Having described the components of the quick-release connector 10 in detail above, particularly according to the disconnected state of the quick-release connector 10, connection assemblies including the quick-release connector 10 will now be described. Additional details of the connected state of the quick-release connector 10 will become apparent through the discussion of the connected state of connection assemblies including the quick-release connector 10.

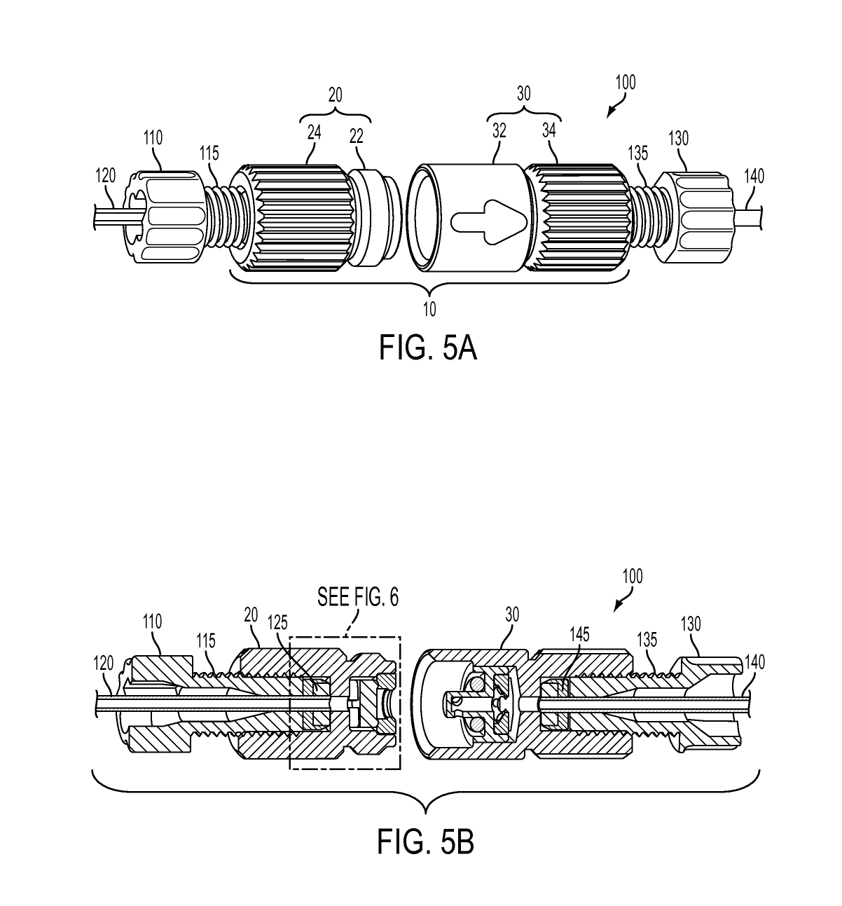

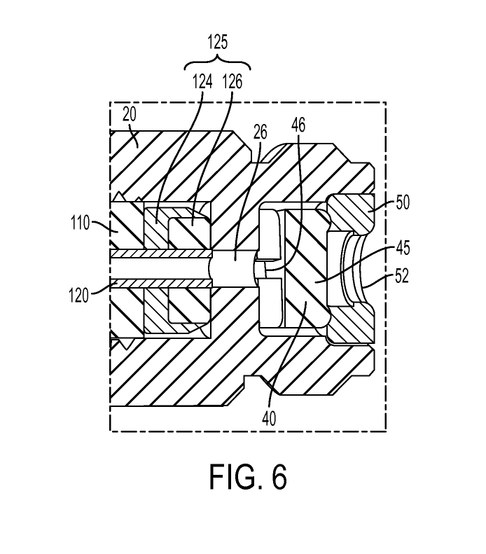

Referring to FIGS. 5A, 5B, and 6, the quick-release connector 10 may be a component of a connection assembly 100. In the connection assembly 100, an inlet fitting 110 having inlet fitting threads 115, for example, may be fastened into the inlet-coupling distal portion 24 of the inlet coupling 20. The inlet fitting 110 may accommodate an inlet tubing 120 that extends through the inlet fitting 110 and an inlet seal 125. It should be understood that threaded connections and a male-type inlet fitting are but one exemplary configuration for the connection assembly and that, in alternative embodiments not shown, other connection types and/or a female-type inlet fitting may be used.

In some embodiments, the inlet fitting 110 may be constructed of any plastic material suitable for fluidic applications such as glass-filled polypropylene, PVC, polyacetal, PEEK, or blends thereof, for example. In other embodiments, the inlet fitting 110 may be constructed of any metal suitable for fluidic applications such as stainless steel, plated brass, or titanium, for example. The inlet tubing 120 may be any type of rigid or semi-rigid tubing material suitable for fluidic applications. In some embodiments, the inlet seal 125 may be a unitary molded piece. In other embodiments, the inlet seal 125 may include a ferrule case 124 and a compressible ferrule 126, as shown in FIG. 6. In exemplary embodiments, the ferrule case 124 may be constructed of a metal such as stainless steel or titanium, for example, and the compressible ferrule 126 may be constructed of a plastic such as polytetrafluoroethylene (PTFE), ETFE, or PEEK, for example. When the inlet fitting 110, the inlet seal 125, and the inlet tubing 120 are fastened into the inlet coupling 20, the inlet fitting 110 compresses the inlet seal against the inlet coupling 20 and the inlet tubing 120 is in leak-free fluidic communication with the inlet channel 26.

The detail view of FIG. 6 shows the configuration of an inlet fitting 110 fastened into the inlet coupling 20 when the inlet coupling 20 is not connected to the outlet coupling 30 (see FIG. 5B). As shown in FIG. 6, when the quick-release connector 10 is in the disconnected state, fluid can flow from the inlet tubing 120, through the inlet channel 26, and around the compressible check valve 40 but is blocked by the sealing member 50 and the check valve base 45 from leaving the inlet coupling 20 through the inlet-coupling proximal portion outlet 52. As described above with reference to FIG. 2, when the quick-release connector 10 is unassembled, the outlet valve 80 is always closed, because no forward fluid pressure can be established to open the outlet valve 80. Thus, when the quick-release connector 10 is disassembled, leakage of fluid from both the inlet coupling 20 and the outlet coupling 30 is prevented, because both the compressible check valve 40 and the outlet valve 80 are closed. The two closed valves of a quick-release connector 10 when disassembled ensure that the inlet fitting 110 and the outlet fitting 130 may be left fastened into the inlet coupling 20 and the outlet coupling 30, respectively, even while the connection assembly 100 is disassembled or reassembled multiple times as desired, without concern of fluid leakage.

Likewise, in the connection assembly 100 an outlet fitting 130 having outlet fitting threads 135, for example, may be fastened into the outlet-coupling distal portion 34 of the outlet coupling 30. The outlet fitting 130 may accommodate an outlet tubing 140 that extends through the outlet fitting 130 and an outlet seal 145. It should be understood that threaded connections and a male-type outlet fitting are but one exemplary configuration for the connection assembly and that, in alternative embodiments not shown, other connection types and/or a female-type outlet fitting may be used.

In some embodiments, the outlet fitting 130 may be constructed of any plastic material suitable for fluidic applications such as glass-filled polypropylene, PVC, polyacetal, PEEK, or blends thereof, for example. In other embodiments, the outlet fitting 130 may be constructed of any metal suitable for use in fluidic devices such as stainless steel, plated brass, or titanium, for example. The outlet tubing 140 may be any suitable type of rigid or semi-rigid tubing material. In some embodiments, the outlet seal 145 may be a unitary molded piece. In other embodiments, the outlet seal 145 may include a ferrule case and a compressible ferrule, analogous to the ferrule case 124 and the compressible ferrule 126 of the inlet seal 125 of FIG. 6. When the outlet fitting 130, the outlet seal 145, and the outlet tubing 140 are fastened into the outlet coupling 30, the outlet fitting 130 compresses the outlet seal 145 against the outlet coupling 30 and the outlet tubing 140 is in leak-free fluidic communication with the outlet channel 36.

In additional embodiments, the inlet fitting 110, the outlet fitting 130, or both may include a torque-limiting mechanism (not shown) and/or compressible ferrules according to commonly-owned U.S. Pat. Nos. 7,954,857 and/or 7,984,933, the entire disclosures of which are incorporated herein by reference.

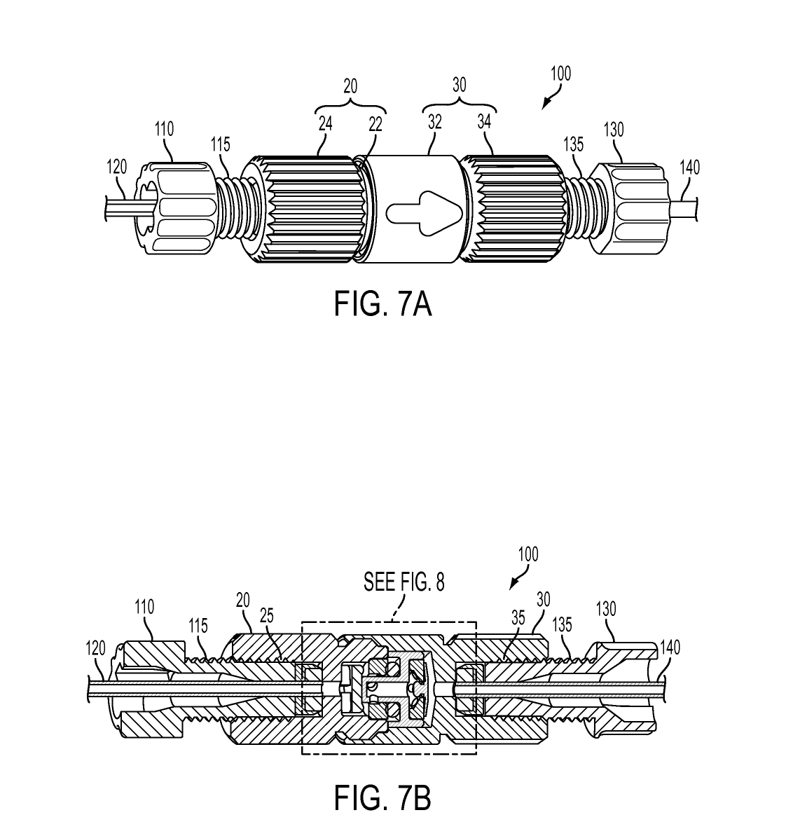

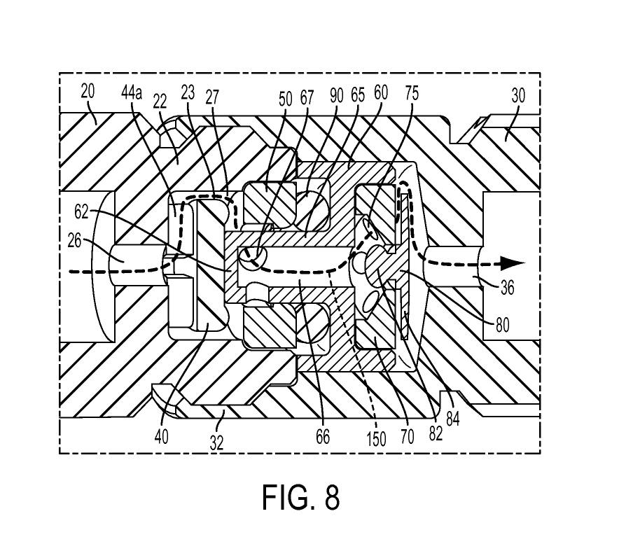

The connection assembly 100 is shown with the quick-release connector 10 in the connected state in FIGS. 7A, 7B, and 8. When in the connected state, the inlet-coupling proximal portion 22 of the inlet coupling 20 inserts directly into the outlet-coupling proximal portion 32 of the outlet coupling 30. In one embodiment, the inlet-coupling proximal portion 22 may be threaded, and threads of the inlet-coupling proximal portion 22 may engage complementary threads in the outlet-coupling proximal portion 32. In such an embodiment, the threads of the inlet-coupling proximal portion 22 and the complementary threads of the outlet-coupling proximal portion 32 may be quad-start threads, such that linear motion is quick and only half a turn is required to connect the inlet coupling 20 and the outlet coupling 30. In another embodiment, no threads are present on the inlet-coupling proximal portion 22 and the outlet-coupling proximal portion 32, such that the inlet coupling 20 and the outlet coupling 30 may be simply snapped together. The inlet fitting threads 115 of the inlet fitting 110 are fastened into the threaded walls at the inlet entrance 25 of the inlet-coupling distal portion 24 of the inlet coupling 20, and the outlet fitting threads 135 of the outlet fitting 130 are fastened into the threaded walls at the outlet exit 35 of the outlet-coupling distal portion 34 of the outlet coupling 30. The inlet tubing 120 and the outlet tubing 140 protrude from opposite ends of the connection assembly 100 and may be connected to a component of a fluidic assembly (not shown) as desired. In other embodiments, the configuration of FIGS. 3A and 3B described above and including the at least one coupling notch 28, the at least one coupling latch 38, and the release lever 39, may be used to secure the inlet-coupling proximal portion 22 to the outlet-coupling proximal portion 32.

A detail view of the connection assembly 100 in the connected state of the quick-release connector is provided in FIG. 8, in which for clarity purposes the inlet fitting and the outlet fitting have been omitted. In the connected state of the quick-release connector 10, the plunger neck portion 65 protrudes through the sealing member 50 and compresses the compressible check valve 40 to place the plunger inlet 67 in fluidic communication with a valve clearance 27 opened between the check valve contact surface and the sealing member 50 when the compressible check valve 40 is compressed.

A fluidic flow path 150 through the detailed portion of the connection assembly 100 is indicated in FIG. 8 with a dark line. The fluidic flow path 150 is established by the opening of both the compressible check valve 40 and the outlet valve 80, whereby fluid may flow first through the inlet channel 26, having entered the inlet channel from the inlet tubing 120 (see FIG. 7B). From the inlet channel 26, the fluid may flow around the compressible check valve 40 across the check valve passage 44a and a lateral channel 23 between the compressible check valve 40 and the inlet-coupling proximal portion 22. The size of the lateral channel 23 is defined by the width of the compressible check valve 40. From the lateral channel 23, fluid may flow through the at least one plunger inlet 67 into the plunger channel 66 inside the plunger neck portion 65 of the plunger body 60. On reaching the end of the plunger channel 66, the fluid may flow through the at least one retainer outlet 75 of the outlet valve retainer 70. The pressure of the fluid flowing through the at least one retainer outlet 75 may cause the outlet valve rim 84 to deflect away from the outlet valve retainer 70, thereby allowing the fluid to pass around the outlet valve 80 and out through the outlet channel 36, where the fluid would enter the outlet tubing 140 (see FIG. 7B). Fluid leakage at joints within the connection assembly 100 is prevented additionally by the sealing of the sealing member 50 against the plunger seal 90 and the sealing of the outlet valve head 82 within the outlet valve retainer 70.

Compared to the connection assembly 100 when in the disconnected state (see FIGS. 5A, 5B, and 6), in which both the outlet valve 80 and the compressible check valve 40 are normally closed, when the connection assembly 100 is in the connected state, the outlet valve 80 is normally closed, but the compressible check valve 40 is normally open. As described above, the outlet valve 80 may be opened when positive fluid pressure in one direction (i.e., from the inlet channel 26 to the outlet channel 36) deflects the outlet valve rim 84 away from the outlet valve retainer 70. The compressible check valve 40 is opened during connection of the connection assembly 100 as the plunger neck portion 65 is inserted through the inlet-coupling proximal portion outlet 52 (see FIGS. 2 and 6) so that the compressing surface 62 of the plunger neck portion 65 contacts the check valve contact surface 48 (see FIG. 4B) of the compressible check valve 40. At full insertion of the plunger body 60, the plunger neck portion 65 compresses the compressible check valve 40 sufficiently far to create the valve clearance 27 between the compressible check valve 40 and the sealing member 50. The creation of the valve clearance 27 allows fluid to pass unimpeded from the lateral channel 23 into the at least one plunger inlet 67, as was not possible in the inlet coupling 20 when the connection assembly 100 was in the disconnected state (see FIG. 6 and description above).

Thus, embodiments of quick-release connectors 10 and connection assemblies 100 including the quick-release connectors 10 have been provided. The connection assemblies 100 employ a two-valve system including a compressible check valve 40 and an outlet valve 80 such as an umbrella valve, for example, to provide leak-free, unidirectional fluidic communication between an inlet tubing 120 and an outlet tubing 140. Thereby, the connection assemblies 100 may be easily and reliably connected, disconnected, and reconnected easily and efficiently without causing fluid leakage. The connection assemblies 100 furthermore do not require mechanisms or mechanical structures such as springs or ball valves, for example, thereby avoiding additional complexity, manufacturing costs, maintenance concerns, size concerns, and higher concerns of chemical incompatibility with the mechanical structures.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

It is noted that terms like “preferably,” “commonly,” and “typically” are not used herein to limit the scope of the appended claims or to imply that certain features are critical, essential, or even important to the structure or function of the claimed subject matter. Rather, these terms are merely intended to highlight alternative or additional features that may or may not be utilized in a particular embodiment.

What is claimed is:

1. A quick-release connector comprising:
an inlet coupling having an inlet-coupling proximal portion, an inlet-coupling distal portion adapted to accommodate an inlet fitting, and an inlet channel providing fluidic communication between the inlet-coupling distal portion and an inlet-coupling proximal portion outlet of the inlet-coupling proximal portion;
a sealing member at the inlet-coupling proximal portion outlet;
a compressible check valve between the sealing member and the inlet channel, the compressible check valve being formed from a resilient elastomeric material;
an outlet coupling having an outlet-coupling proximal portion, an outlet-coupling distal portion adapted to accommodate an outlet fitting, and an outlet channel providing fluidic communication between the outlet-coupling proximal portion and the outlet-coupling distal portion;
a plunger body disposed in the outlet-coupling proximal portion, the plunger body having a plunger neck portion, a plunger channel defined through the plunger body, and a plunger inlet on the plunger neck portion and in fluidic communication with the plunger channel; and
an outlet valve between the plunger channel and the outlet channel, the outlet valve preventing fluid flow from the outlet channel to the plunger channel and allowing fluid flow from the plunger channel to the outlet channel;
wherein:
in a disconnected state of the quick-release connector, a check valve contact surface of the compressible check valve forms a seal against the sealing member that prevents fluid flow from the inlet channel to the inlet-coupling proximal portion outlet; and
in a connected state of the quick-release connector, the plunger neck portion protrudes through the sealing member and compresses the compressible check valve to place the plunger inlet in fluidic communication with a valve clearance opened between the check valve contact surface and the sealing member when the compressible check valve is compressed.

2. The quick-release connector of claim 1, wherein:
the plunger neck portion comprises a compressing surface, and
in the connected state, the compressing surface pushes against the check valve contact surface to compress the compressible check valve.

3. The quick-release connector of claim 1, wherein:
the compressible check valve comprises a check valve base that includes the check valve contact surface, and at least two check valve legs attached to the check valve base opposite the check valve contact surface;
the at least two check valve legs define at least one check valve passage between adjacent check valve legs; and
the at least one check valve passage enables fluidic communication between the inlet channel and a lateral channel adjacent to the check valve base.

4. The quick-release connector of claim 3, wherein the compressible check valve is a single unitary body without any seams, joints, or mechanical components.

5. The quick-release connector of claim 3, wherein the outlet valve is an umbrella valve having an outlet valve head and an outlet valve rim.

6. The quick-release connector of claim 5, further comprising an outlet valve retainer that accommodates the outlet valve head and at least one retainer outlet covered by the outlet valve rim, such that forward fluid flow is enabled from the plunger channel through the at least one retainer outlet around the outlet valve rim and to the outlet channel, and such that reverse fluid flow is prevented from the outlet channel to the plunger channel.

7. The quick-release connector of claim 3, wherein:
the compressible check valve comprises four check valve legs that define four check valve passages; and
the four check valve passages intersect at a passage junction over the inlet channel.

8. The quick-release connector of claim 1, wherein the check valve contact surface comprises a check valve rim raised around an outer periphery of the check valve contact surface.

9. The quick-release connector of claim 1, wherein the outlet valve is an umbrella valve having an outlet valve head and an outlet valve rim.

10. The quick-release connector of claim 9, further comprising an outlet valve retainer that accommodates the outlet valve head and at least one retainer outlet covered by the outlet valve rim, such that forward fluid flow is enabled from the plunger channel through the at least one retainer outlet around the outlet valve rim and to the outlet channel, and such that reverse fluid flow is prevented from the outlet channel to the plunger channel.

11. The quick-release connector of claim 1, wherein in the connected state the compressible check valve is normally open and the outlet valve is normally closed.

12. The quick-release connector of claim 1, wherein the compressible check valve is formed from EPDM rubber, FKM/FPM rubber, FFKM rubber, nitrile rubbed, isoprene rubber, or silicone.

13. A connection assembly comprising:
an inlet coupling having an inlet-coupling proximal portion, an inlet-coupling distal portion, and an inlet channel providing fluidic communication between the inlet-coupling distal portion and an inlet-coupling proximal portion outlet of the inlet-coupling proximal portion;
a sealing member at the inlet-coupling proximal portion outlet;
a compressible check valve between the sealing member and the inlet channel, the compressible check valve being formed from a resilient elastomeric material;
an outlet coupling having an outlet-coupling proximal portion, an outlet-coupling distal portion, and an outlet channel providing fluidic communication between the outlet-coupling proximal portion and the outlet-coupling distal portion;
a plunger body disposed in the outlet-coupling proximal portion, the plunger body having a plunger neck portion, a plunger channel defined through the plunger body, and a plunger inlet on the plunger neck portion and in fluidic communication with the plunger channel;
an outlet valve between the plunger channel and the outlet channel, the outlet valve preventing fluid flow from the outlet channel to the plunger channel and allowing fluid flow from the plunger channel to the outlet channel;
an inlet fitting coupled to the inlet-coupling distal portion, the inlet fitting securing an inlet tubing to be in fluidic communication with the inlet channel; and
an outlet fitting coupled to the outlet-coupling distal portion, the outlet fitting securing an outlet tubing to be in fluidic communication with the outlet channel,
wherein:
in a disconnected state of the inlet coupling and the outlet coupling, a check valve contact surface of the compressible check valve forms a seal against the sealing member that prevents fluid flow from the inlet channel to the inlet-coupling proximal portion outlet; and
in a connected state of the inlet coupling and the outlet coupling, the plunger neck portion protrudes through the sealing member and compresses the compressible check valve to place the plunger inlet in fluidic communication with a valve clearance opened between the check valve contact surface and the sealing member when the compressible check valve is compressed, whereby unidirectional fluidic communication is enabled from the inlet tubing to the outlet tubing.

14. The connection assembly of claim 13, wherein at least one of the inlet fitting and the outlet fitting comprises fitting threads that engage corresponding threads in the inlet-coupling distal portion or the outlet-coupling distal portion.

15. The connection assembly of claim 13, wherein at least one of the inlet fitting and the outlet fitting comprises a compressible ferrule that seals the inlet tubing at the inlet channel or the outlet tubing at the outlet channel.

16. The connection assembly of claim 13, wherein:
the plunger neck portion comprises a compressing surface; and
in the connected state the compressing surface pushes against the check valve contact surface to compress the compressible check valve.

17. The connection assembly of claim 13, wherein:
the compressible check valve comprises a check valve base having a check valve contact surface and at least two check valve legs attached to the check valve base opposite the check valve contact surface;
the at least two check valve legs define at least one check valve passage between adjacent check valve legs; and
the at least one check valve passage enabling fluidic communication between the inlet channel and a lateral channel adjacent to the check valve base.

18. The connection assembly of claim 17, wherein the outlet valve is an umbrella valve having an outlet valve head and an outlet valve rim.

19. The connection assembly of claim 18, further comprising an outlet valve retainer that accommodates the outlet valve head and at least one retainer outlet covered by the outlet valve rim, such that forward fluid flow is enabled from the plunger channel through the at least one retainer outlet around the outlet valve rim and to the outlet channel, and such that reverse fluid flow is prevented from the outlet channel to the plunger channel.

20. The connection assembly of claim 12, wherein the compressible check valve is formed from EPDM rubber, FKM/FPM rubber, FFKM rubber, or silicone.
